(19) United States
(12) Patent Application Publication
(10) Pub. No.: US 2011/0005899 A1
(43) Pub. Date: Jan. 13, 2011

(54) METHOD AND CONVEYOR BELT SYSTEM HAVING AT LEAST ONE CONVEYOR BELT FOR TRANSPORTING FLAT TRANSPORT GOODS

(76) Inventor: Janusz Grzelak, Berlin (DE)

Correspondence Address: NOTARO, MICHALOS & ZACCARIA P.C., 100 DUTCH HILL ROAD, ORANGEBURG, NY, 10962, US

(21) Appl. No.: 12/922,623

(22) PCT Filed: Jan. 26, 2009
(86) PCT No.: PCT/DE09/00105

§ 371 Date: Sep. 14, 2010

(30) Foreign Application Priority Data
Mar. 16, 2008 (DE) 20 2008 003 610.0

(51) Int. Cl. B65G 15/58

(52) U.S. Cl. 198/471.1

(57) ABSTRACT

The invention relates to a method for transporting flat transport goods, particularly substrates such as silicon wafers and solar cells, on at least one conveyor belt of a conveyor belt system, wherein the substrates are held on a conveying surface of the conveyor belt at least in some cycles during the transport by means of suction. In order to ensure improved slip-resistant and gentle transport of the substrates on the conveyor belt, according to the invention along at least one of the two longitudinal edges of the strap of the conveyor belt that extend in the transport direction, in a plurality of positions spaced with respect to each other, underpressure that is based on the Bernoulli effect is generated by means of a guidance of a pressure medium, such as compressed air, that is controlled by a flow system, and, as a result of the pressure difference between the atmospheric pressure and the underpressure generated at the respective position formed at the respective position on the longitudinal edge of the belt, the substrates are held with uniform pressure on the transport surface of the conveyor belt with the contact surface.

The invention relates to a method of transporting flat transport goods, more particularly substrates such as silicon wafers and solar cells on at least one conveyor belt of a conveyor belt system, wherein the substrates are held on a transport surface of the conveyor belt at least cyclically during transportation by means of suction.

The invention also relates to a conveyor belt system with at least one conveyor belt for transporting flat transport goods, more particularly substrates such as silicon wafers and solar cells, and with a suction device which holds the substrates by means of suction on the transport surface of the at least one conveyor belt at least cyclically during transportation.

The transporting of silicon wafers for the production of solar cells is usually carried out with grippers or on a conveyor belt which can comprise several belts. Because of the machines used in the production process transportation of the wafers takes place in cycles, which means the conveyor belts and grippers constantly have to be accelerated and braked. The wafers lying on the conveyor belts can normally only remain in position due to gravity and fraction during transportation. In the case of wafers being transported with grippers, their position is only retained through suction and friction on the contact surface. However if acceleration and braking of the conveyor belts takes places too quickly the friction values of the conveyor belts and the contact surface of the gripper are exceeded, resulting in slipping of the wafer which then loses its original position in relation to the conveyor belt or gripper. Furthermore, as a result of too little adhesion between the wafer and conveyor belt the wafer may fall off the conveyor belt.

In order to increase the adhesion on the conveyor belt, conveyor belts made of different materials with different surfaces are used. In order to further increase the adhesion of flat transport goods such as wafers or solar cells on a conveyor belt, in a conveyor belt system known from DE 10 2004 050 463 B3, conveyor belts are designed with apertures up to their surface which are evenly distributed over the surface of the conveyor belt and are connected to a vacuum suction device. Apart from the fact that not every conveyor belt is suitable for such use, the suction force, which only acts on the wafer placed on the surface of the conveyor belt in the immediate vicinity of each aperture, must be selected to be relatively low, as if too great a suction force is used the wafer could be sucked through the aperture and damaged.

A system for structuring solar modules known from DE 10 2006 033 296 A1 comprises a transport system with an air cushion system for transporting a solar module in one transporting plane, whereby in one processing area a pressure-vacuum table is provided for simultaneously generating a vacuum and an overpressure between the solar module and a plate and the solar module is constantly kept at a distance from the plate by a generated air cushion.

The aim of the invention is to ensure increased adhesion of the wafers on the conveyor belt in a gentle manner, thereby allowing higher speeds and accelerations of the conveyor belt without impairing the positioning of the wafer on the relevant transport area. The objective of the invention is therefore to design a method and conveyor belt system of the type mentioned in the introductory section in such a way that pressure conditions are produced in a large area around the conveyor belts which assure improved slip-resistance and gentle transportation of the substrates on the conveyor belt in a cost-effective manner.

According to the invention this objective is achieved in that along at least one of the two longitudinal edges of the belt of the conveyor belt system that extend in the direction of transporting, in a plurality of positions spaced with regard to each other an underpressure based on the Bernoulli effect is produced by flow guidance, controlled by a flow system, of a pressure medium such as compressed air, and, as a result of the pressure difference between the atmospheric pressure and the underpressure generated at the respective position on the longitudinal edge of the belt, the substrates are held with uniform pressure on the transport surface of the conveyor belt with the contact surface.

Preferably during the transporting of the substrates, of the plurality of positions on the longitudinal edge of the belt, at which the overpressure based on the Bernoulli effect is generated, only a certain number of positions, which are at any moment consecutively covered by a substrate in the direction of transporting, are controlled by the compressed air supply for producing the underpressure based on the Bernoulli effect, whereby during transportation of the substrates, on covering of the next position in the transporting direction on the longitudinal edge of the belt by the forward edge of each substrate, control of the following position through the supply of compressed air is automatically activated, and at the position on the longitudinal edge of the belt which is cleared by rear edge of the substrate while being transported the supply of compressed air is switched off.

If the substrates are transported on a conveyor belt with continuously circulating belts, advantageously both along the longitudinal edge of the upper support surface of the continuous belt as well as along the longitudinal edge of the lower support surface of the continuous belt moving in the opposite direction, at a plurality of positions, spaced with regard to each other, on the longitudinal edge an underpressure based on the Bernoulli effect is generated through the flow guidance of the pressure medium, whereby the substrates are held with their contact surface at uniform pressure at the plurality of position by means of the difference between the atmospheric pressure and the underpressure generated at the relevant position.

If the substrates are being transported by means of a conveyor belt system with two parallel conveyor belts moving in the same direction, whereby the opposite end sections of both conveyor belts overlap and are arranged at a distance from each other, advantageously the substrates being transported on the transport surface of the conveyor belt can, through alternating generation of the underpressure at the corresponding positions on the longitudinal edge of the belt of the lower and the upper conveyor belt, be transferred to the opposite transport surface of the upper conveyor belt, place thereon and held by suction.

The underpressure based on the Bernoulli effect can also be produced along both longitudinal edges of the belt of the conveyor belt running in the direction of transport at positions corresponding to each other. Preferably the distance between the positions at which the underpressure based on the Bernoulli effect is generated on each longitudinal edge of the belt is selected to be of equal size, and the underpressure generated on the basis of the Bernoulli effect at the relevant positions on each longitudinal edge of the belt is of equal magnitude.

Suitably the supply of the pressure medium, controlled by the flow system, for producing the underpressure based on the Bernoulli effect at each of the plurality of positions on the longitudinal edge or longitudinal edges of the belt of the conveyor belt is computer-controlled.

The objective of the invention is also achieved in accordance with the invention by the conveyor belt system set out in the introductory section, which is characterised in that
along each of the two longitudinal edges of the belt of the conveyor belt running in the direction of transport arranged at corresponding positions there is at least one outflow opening assigned to a chamber of a device generating a Bernoulli suction effect,
a pressure medium such as compressed air is supplied to the chamber via at least one inlet opening, the cross-section of which is greater than the cross-section of the outlet opening of the chamber and
the substrates are held with uniform contact surface pressure on transport surface of the transport belt by means of the pressure difference between the atmospheric pressure and the underpressure caused by the Bernoulli suction effect produced by the Bernoulli suction device along the longitudinal edges of the conveyor belt.

Preferably the Bernoulli suction device comprises a plurality of chambers and a number of outflow openings which is the same for each longitudinal edge of the belt of the conveyor belt, whereby the outflow openings are arranged at equal distances from each other in each corresponding position. The plurality of chambers and number of outflow opening along each side of the belt of the conveyor belt can correspond and two outflow openings can be assigned to each chamber, which are arranged on the two longitudinal edge of the belt of the conveyor belt in the positions corresponding to each other.

In order to reduce the energy requirement, the conveyor belt system in accordance with the invention is designed so that during the transportation of the substrates, of the plurality of chambers of the Bernoulli suction devices, only a certain number of chambers, the outflow openings of which, assigned to them one after the other in the direction of transportation, are covered at any time during the transporting of the substrates, are controlled by the Bernoulli suction device, whereby during the transportation of the substrate, on covering of the next outflow opening in the direction in the transport direction by the forward edge of each substrate in the direction of transporting, the chamber assigned to this outflow opening is automatically controlled, and the chamber to which his assigned the outflow opening next uncovered by the rear edge of the substrate in question during its transportation, is switched off.

The conveyor belt can comprise continuous belts, deflected via a roller arrangement, on the upper contact surface and lower contact surface of which, which run in opposite directions, the Bernoulli suction effect is produced along the longitudinal edges of the continuous belt of the conveyor belts by the Bernoulli suction device, whereby the upper contact surface and the lower contact surface of the continuous belt form the transport surface of the conveyor belt, on which the substrates are held with uniform pressure through the difference in pressure between the atmospheric pressure and the underpressure caused by the Bernoulli suction effect produced along the longitudinal edges of the continuous belt of the conveyor belt by the Bernoulli suction device.

Preferably two parallel conveyor belts moving in the same direction can be provided which overlap at their opposite end section and are arranged at a distance from each other, whereby the substrates on the transport surface of the lower conveyor belt can, through alternating control of the corresponding outflow opening provided on the longitudinal edges of the belts of the lower and upper conveyor belt and assigned to the chambers of the relevant Bernoulli suction device, be transferred to the transport surface of the upper conveyor belt and placed thereon and held in place.

The conveyor belt system in accordance with the invention guarantees a high degree of and gentle adhesion of the transport goods on the transport surface at high speeds, acceleration and braking of the conveyor belt. The pressure conditions produced by the Bernoulli suction device around the conveyor belt also allow transporting of the flat transport goods on the lower contact surface of the conveyor belt, so that, for example, wafers can be transported “upside down” or in all possible directions at high speed and acceleration on the conveyor belt without impairment of their position on the transport surface of the conveyor belt. In addition, the conveyor belt system in accordance with the invention allows considerable savings in production and energy costs as the compressed air supply suitably takes place synchronised with the belt movement.

In addition to substrates such as silicon wafers and solar cells, many other objects made of glass, ceramic, metal, wood or plastic, e.g. CDs, circuit boards, displays and suchlike can be transported in a slip-resistant manner with the device and/or conveyor belt system in accordance with the invention. Moreover, the use of the method in accordance with the invention is of advantage in sorting installations of all types as well as in the semiconductor industry.

The invention will now be described with the aid of the drawings, in which

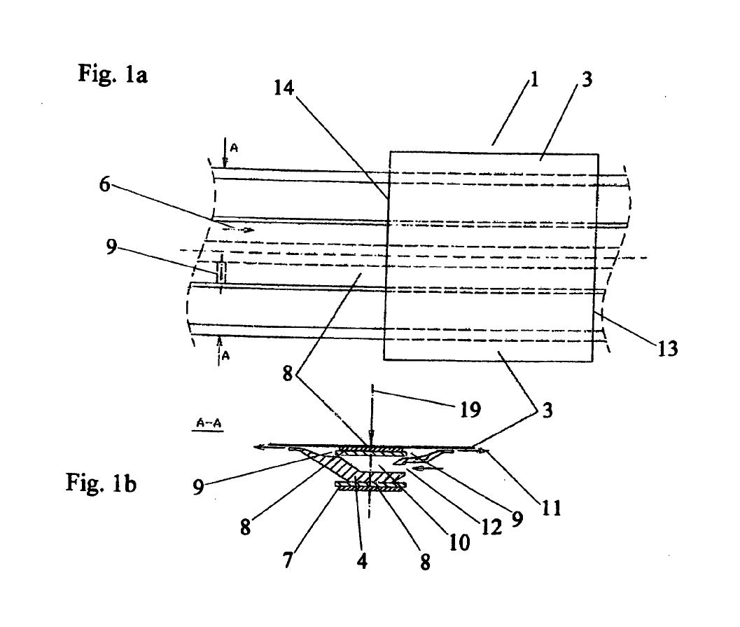

FIG. 1a is a view from above of a section of one embodiment of the conveyor belt system with a conveyor belt,

FIG. 1b is a view of a section through planes A-A in FIG. 1a,

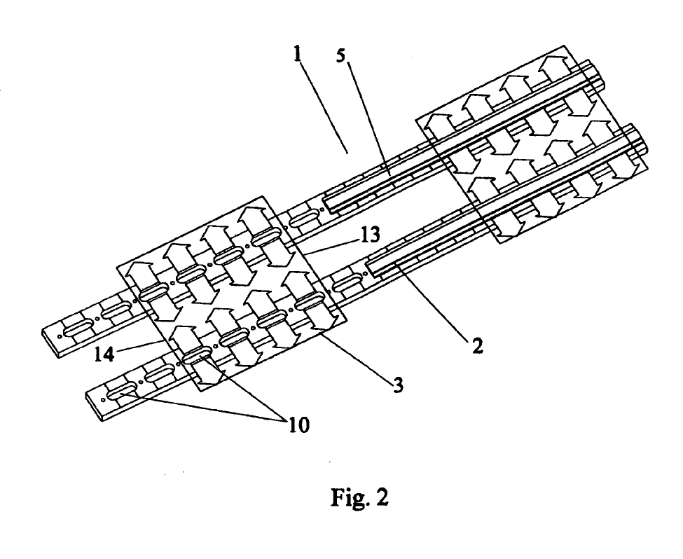

FIG. 2 is perspective view of a schematically shown section of a preferred form of embodiment of the conveyor belt with two parallel conveyor belts, wherein in each case half of each conveyor belt is shown without covering the chambers of the Bernoulli suction device,

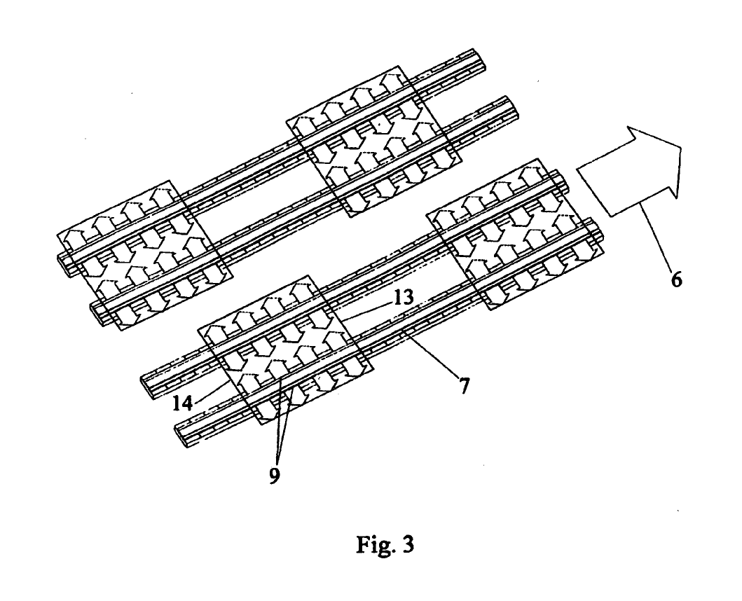

FIG. 3 is a perspective view similar to FIG. 2 the section shown in FIG. 2 with full covering of the chamber of the Bernoulli suction device, whereby the section for clarifying the consecutive controlling of a number of outflow openings of the Bernoulli suction device is shown twice and on top of each other with positions of the wafers offset with regard to each other in the direction of transport.

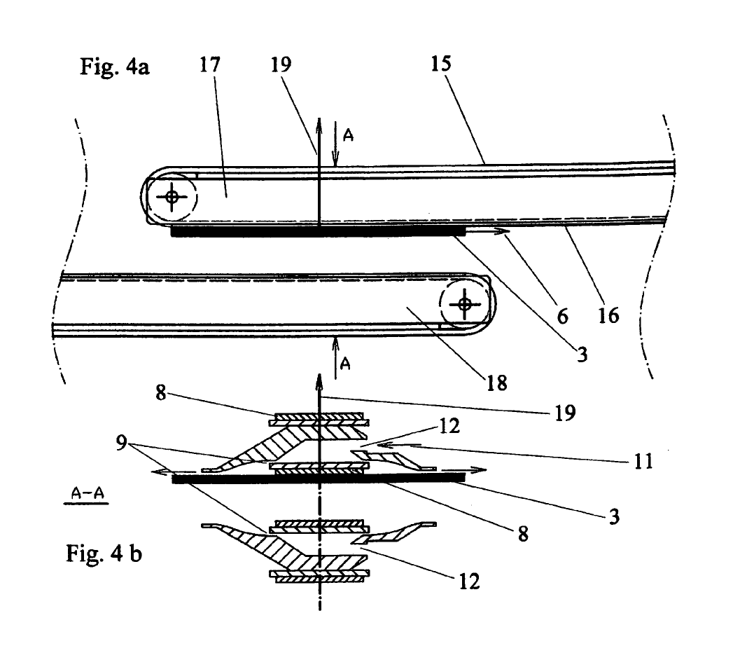

FIG. 4a is a side view of a section of a schematically shown other form of embodiment of the conveyor belt system, in which the opposite end sections of two parallel conveyor belts overlap each other and the wafers can be transferred from one conveyor belt to the other conveyor belt through the Bernoulli suction effect.

FIG. 4b show a view of section along plane A-A of FIG. 4b,

As can be seen from the form of embodiment of the conveyor belt system 1 shown schematically in FIG. 1a, it comprises a conveyor belt 2 for transporting substrates such as, for example, silicon wafers and solar cells, as well as a Bernoulli suction device 4, which is shown in FIG. 1b in a section through plane A-A in FIG. 1a. Along each of the longitudinal edges 7 of the belt 8 of the conveyor belt 2 running in the direction of transporting 6, the Bernoulli suction device 4 comprises at least one outflow opening 9 of a chamber 10 in corresponding positions to which compressed air 11 is supplied via an inflow opening 12 from a source of compressed air, which is not shown. The cross-section of the inflow opening 12 is greater than the cross-section of the outflow opening 9 of the chamber 10. The substrates 3 are held evenly pressed onto the transport surface 5 of the conveyor belt 2 through the force acting in the direction of arrow 19 created by means of the difference in pressure between the atmospheric pressure and the underpressure brought about by the Bernoulli effect generated by the Bernoulli suction device along both longitudinal edge 7 of the belt 8.

FIGS. 2 and 3 show an energy-saving and cost-reducing preferred form of embodiment of the conveyor belt system 1 in which two parallel conveyor belts 2 are envisaged. Here the Bernoulli suction device 4 has a number a of chambers 10 and number b of outflow openings 9, whereby the number a of outflow openings 9 on each longitudinal edge of the belt 8 of each conveyor belt 2 is the same, the outflow openings 9 are arranged at the same distance from each other in the corresponding positions and the number a of chamber 10 and the number b of outflow opening 9 along each longitudinal edge of the belt 8 of each of the two conveyor belts 2 corresponds.

In FIG. 3 on half of each conveyor belt 2 the covering of the chambers 10 of the Bernoulli suction device is omitted to clarify the arrangement of the chambers 10. Here it can be seen that two outflow openings 9 are allocated to each chamber 10, which are arranged in positions corresponding to each other on the two longitudinal edges 7 of the belt 8 of each of the conveyor belts 2.

FIG. 3 shows that in this preferred form of embodiment of the conveyor system 1 of the plurality a of chambers 10 of the Bernoulli suction device 4 only a certain number c of chambers, the outflow opening 9 assigned to them one after the other in the direction of transportation along each longitudinal edge 7 of the belt 8 of each conveyor belt 2, are covered by a substrate 3 at any time during the transporting of the substrates 3, are controlled by the Bernoulli suction device 4. During the transportation of the substrates 3, on covering of the next outflow opening 9 in the direction in the transport direction 6 by the forward edge 13 of each substrate 3 in the direction of transporting 6, the chamber 10 assigned to this outflow opening 9 is automatically controlled, and the chamber to which is assigned the outflow opening 9 next uncovered by the rear edge 14 of the substrate 3 in question during its transportation, is switched off.

FIGS. 4a and 4b show a further form of embodiment of the conveyor belt system 1 in which, as shown in FIG. 4a, two parallel conveyor belts 2 with the same direction of movement 6 overlap at their opposite end sections 17 and 18 and are arranged at distance on top of each other.

As shown in FIG. 4b, which shows a section through overlapping end sections 17; 18 of the two conveyor belts 2 along plane A-A in FIG. 4a, a Bernoulli suction device 4 is assigned to each conveyor belt 2 in such a way that substrates 3 on the transport surface 5 of the lower conveyor belt 2 can, through alternate controlling of the corresponding outflow openings 9 on the corresponding longitudinal edges 7 of the belt 8 of the lower and the upper conveyor belt 2 and through the Bernoulli suction effects brought about thereby, be transferred to the transport surface 5 of the upper conveyor belt 2, placed thereon and held in place. The force is exerted in the direction of arrow 19.

### LIST OF REFERENCE NUMBERS

1 Conveyor belt system

2 Conveyor belt

3 Transport goods, substrates, silicon wafers, solar cells

4 Suction system, flow system

5 Transport surface

6 Transport direction

7 Longitudinal edges

8 Belt

9 Outflow openings, positions

10 Chamber

11 Pressure fluid, compressed air

12 Inflow opening

13 Front edge of the substrate

14 Rear edge of the substrate

15 Upper contact surface of the conveyor belt

16 Lower contact surface of the conveyor belt

17 End section of the upper conveyor belt

18 End section of the lower conveyor belt

19 Direction of exerted force

a Plurality of chambers

b Number of outflow openings

c Certain number of outflow openings

1. A method of transporting flat transport goods, more particularly substrates such as silicon wafers and solar cells on at least one conveyor belt of a conveyor belt system, wherein the substrates are held on a transport surface of the conveyor belt at least cyclically during transportation by means of suction,
characterised in that
along at least one of the two longitudinal edges of the belt of the conveyor belt system that extend in the direction of transporting, in a plurality of positions spaced with regard to each other, underpressure based on the Bernoulli effect is produced by flow guidance, controlled by a flow system, of a pressure medium such as compressed air, and, as a result of the pressure difference between the atmospheric pressure and the underpressure generated at the respective position on the longitudinal edge of the belt, the substrates are held with uniform pressure on the transport surface of the conveyor belt with the contact surface.

2. The method according to claim 1 characterised in during the transportation of the substrates, of the plurality of positions on the longitudinal edge of the belt on which the underpressure based on the Bernoulli effect is to be produced, only a certain number of positions, which in the direction of transport are consecutively covered at any time by a substrate during the transporting of the substrates, are controlled by compressed air supply to produce the underpressure based on the Bernoulli effect, whereby during the transportation of the substrate, on covering of the position on the longitudinal edge of the belt in the transport direction by the forward edge of each substrate, the next position is automatically controlled by the supply of compressed air, and on the position on longitudinal edge next uncovered by the rear edge of the substrate in question during its transportation, the compressed air supply is switched off.

3. The method in accordance with claim 1, in which the substrates are transported on a conveyor belt with a circulating continuous belt,
characterised in that
both along the longitudinal edge of the upper contact surface of the continuous belt as well as along the longitudinal edge of the lower contact surface of the continuous belt moving in the opposite direction, at a number of positions at a distance from each other on the longitudinal edges an underpressure, based on the Bernoulli effect, brought through flow guidance of the pressure fluid, is produced, and the substrates are held evenly pressed on the upper contact surface as well as on the lower contact surface of the continuous belt in the relevant direction of transport at the plurality of positions through the difference in pressure between the atmospheric pressure and the underpressure produced at the relevant position.

4. The method in accordance with claim 1 in which the substrates are transported by a conveyor belt system with two parallel conveyor belts moving in the same direction, whereby the opposite end sections of the two conveyor belts overlap and are arranged at distance from one another,
characterised in that
through alternate production of the underpressure at each of the corresponding positions on the longitudinal edge of the belt of the lower and of the upper conveyor belt, the substrates being transported on the transport surface of the lower conveyor belt are transferred to the opposite transport surface of the upper conveyor belt, placed thereon and held in place by suction.

5. The method in accordance with claim 1 characterised in that along both longitudinal edge of the belt of the conveyor belt running in the direction of transport, an underpressure based on the Bernoulli effect is produced at positions corresponding to each other.

6. The method in accordance with claim 1 characterised in that the distance between the positions at which an underpressure based on the Bernoulli effect is produced on each longitudinal edge of the belt is the same.

7. The method in accordance with claim 1 characterised in that the underpressure, based on the Bernoulli effect, produced at each of the positions on each longitudinal edge of the belt is of equal magnitude.

8. The method in accordance with claim 1 characterised in that the supply of compressed air, regulated by means of the flow system, for producing the underpressure based on the Bernoulli effect takes place in a computer-controlled manner on every one of the plurality of positions on the longitudinal edge or longitudinal edges of the belt of the conveyor belt.

9. A conveyor belt system (1) with at least one conveyor belt (2) for transporting flat transport goods, more particularly substrates (3) such as silicon wafers and solar cells and with a suction device (4), with which the substrates (3) are held by means of suction on a transport surface (5) of the at least one conveyor belt (2) at least cyclically during transportation, characterised in that
arranged in corresponding positions along each of the two longitudinal edges (7) of the belt (8) of the conveyor belt (2) running in the direction of transport (6) is at least one outflow opening (9) of at least one chamber (10) of device (4) generating a Bernoulli suction effect,
a pressure fluid (11) such as compressed air is supplied to the chamber (10) via at least one inflow opening (12), the cross-section of which is larger than the cross-section of the outflow opening (9) of the chamber (10), and
the substrates (3) are held with uniform pressure on the transport surface (5) of the conveyor belt (2) by means of the pressure difference between the atmospheric pressure and the underpressure caused the Bernoulli effect generated by the Bernoulli suction device (4) along the longitudinal edges (7) of the belt (8) of the conveyor belt (2).

10. The conveyor belt system in accordance with claim 9 characterised in that the Bernoulli suction device (4) has a plurality (a) of chambers (10) and a number (b) of outflow openings, which are the same in relation to each longitudinal edge (7) of the belt (8) of the conveyor belt (2), whereby the outflow openings (9) are arranged at equal spacing from each other in the corresponding position.

11. The conveyor belt system in accordance with claim 10 characterised in that
the plurality (a) of chambers (10) and the number (b) of outflow openings (9) along each of the two longitudinal edges (7) of the belt (8) of the conveyor belt (2) correspond and
assigned to each chamber (10) are two outflow openings (9) arranged on the two longitudinal edges (7) of the belt (8) of the conveyor belt (2) in positions corresponding to each other.

12. The conveyor belt system in accordance with claim 9, characterised in that during the transportation of the substrates (3) of the plurality (a) of chambers (10) of the Bernoulli suction device (4) only a certain number (c) of chambers (10), the outflow openings (9) assigned to them one after the other in the direction of transportation (6) along each longitudinal edge (7) of the belt (8) of the conveyor belt (2), are covered by a substrate (3) at any time during the transporting of the substrates (3), are controlled by the Bernoulli suction device (4) whereby during the transportation of the substrates (3), on covering of the next outflow opening (9) in the direction in the transport direction (6) by the forward edge (13) of each substrate (3) in the direction of transporting (6), the chamber (10) assigned to this outflow opening (9) is automatically controlled, and the chamber (10) to which is assigned the outflow opening (9) next uncovered by the rear edge (14) of the substrate (3) in question during its transportation, is switched off.

13. The conveyor belt system in accordance with claim 9 characterised in that the conveyor belt (2) has a circulating continuous belt (8), on the upper contact surface (15) as well as on the lower contact surface (16) of which, moving in the opposite direction, the Bernoulli suction effect is produced by the Bernoulli suction device (4) along the longitudinal edges (7) of the continuous belt (8) of the conveyor belt (2), and the upper contact surface (15) as well as the lower contact surface (16) of the continuous belt (8) in their respective direction of movement each form the transport surface (5) of the conveyor belt (2) on which the substrates (3) are held with uniform pressure due to the difference in pressure between the atmospheric pressure and the underpressure due to the Bernoulli effect produced along the longitudinal edges (7) of the continuous belt (8) of the conveyor belt (2) by the Bernoulli suction device (4).

14. The conveyor belt system in accordance with claim 9 characterised in that two parallel conveyor belts (2) moving in the same direction (6) overlap at their opposite end sections (17; 18) and are arranged at a distance from each other, whereby the substrates (3) on the transport surface (5) of the lower conveyor belt (2) can, through alternating control of the corresponding outflow openings (9) provided on the longitudinal edges (7) of the belts (8) of the lower and upper conveyor belt (2) and assigned to the chambers (10) of the relevant Bernoulli suction device (4), be transferred to the transport surface (5) of the upper conveyor belt (2) and placed thereon and held in place.
